(19) United States
(12) Patent Application Publication
(10) Pub. No.: US 2025/0223119 A1
(43) Pub. Date: Jul. 10, 2025

(54) SYSTEM FOR THE AUTOMATIC LOADING AND UNLOADING OF PARCEL DELIVERY VEHICLES AND A SUITABLE PARCEL DELIVERY VEHICLE FOR THIS PURPOSE

(71) Applicant: INNOVATIVE ROBOT DELIVERY GMBH, Boon (DE)

(72) Inventors: Christof Schares, Boon (DE); Boris Mayer, Boon (DE); Christian Borger, Boon (DE)

(21) Appl. No.: 18/854,430

(22) PCT Filed: Mar. 31, 2023
(86) PCT No.: PCT/EP2023/058591

§ 371 Date: Oct. 4, 2024

(30) Foreign Application Priority Data
Apr. 4, 2022 (DE) 10 2022 203 338.8

(51) Int. Cl. B65G 67/20; B25J 9/16; G05D 1/667; G05D 109/10

(52) U.S. Cl. CPC B65G 67/20; B25J 9/162; G05D 1/667; G05D 2109/10

(57) ABSTRACT

A system for automatic loading of parcel delivery vehicles. The system includes at least one pick-up unit for picking up individual parcels, at least one transport unit for transporting parcels, at least one loading unit for loading parcel delivery vehicles and a control component, the parcel delivery vehicles being equipped with storage units accessible by the loading unit, and that the control component is arranged to control the loading process of a parcel delivery vehicle by the interaction of the pick-up unit, transport unit and loading unit and to store information about the position of each parcel in the storage unit and to make the information about the position of each parcel in the storage unit accessible to a delivery person upon reaching a handover location. The invention further relates to a parcel delivery vehicle suitable for usage in the system.

### CROSS-REFERENCE TO RELATED APPLICATIONS

The subject patent application is a national phase application of International Patent Application No PCT/EP2023/058591, which claims priority to, and all the benefits of, German Patent Application No 10 2022 203 338.8, filed on Apr. 4, 2022, the entire contents of which are incorporated by reference herein.

### FIELD OF THE INVENTION

The present invention relates to a system for the automatic loading and unloading of parcel delivery vehicles and a parcel delivery vehicle suitable for the system.

### BACKGROUND

Parcel delivery vehicles are, among other things, part of logistics systems for transporting a large number of parcels to recipients and are used for the delivery of parcels to recipients.

In this application, the term logistics system refers to a system that can perform at least one of the following processing operations on objects, in particular parcels: delivery (to the logistics system), transportation, sorting, storage, commissioning, delivery (to the parcel recipient).

A logistics system comprises at least one inbound distribution center, in which a parcel is sorted for the first time after delivery by the shipper for onward transport to the delivery area, and at least one outbound distribution center, in which the parcel is sorted to a specific delivery depot after delivery from the inbound distribution center. The term delivery depot refers to the facilities of the logistics system in which parcels are sorted for the last time and prepared for delivery tours by parcel delivery vehicles to the parcel recipients.

Currently, parcel delivery vehicles are loaded manually by the delivery staff at the delivery depots before they begin the actual delivery of the parcels to the recipients. The loading process varies depending on the degree of automation and mechanization at the logistics service provider's delivery depots. There are essentially three different procedures:
A) In delivery depots with a low level of automation and mechanization, there is a simple roller conveyor in the middle of the delivery depot onto which the parcels are placed. The delivery staff or sorting personnel stand on both sides of the roller conveyor and manually remove the parcels assigned to their route from the roller conveyor, if necessary supported by light signals projected onto the parcel (so-called sort by light).
B) In delivery depots with a medium degree of automation and mechanization, the parcels are diverted from a simple conveyor belt with a throughput of approx. 1,500 parcels/hour, for example, to chutes that cannot hold the parcels for a complete tour. The parcels are therefore loaded manually at the chutes into roll containers assigned to the individual tours and stored in them until they are loaded into the delivery vehicle.
C) In delivery depots with a high degree of automation and mechanization, the parcels are automatically sorted into the respective delivery routes during the night with a high throughput of approx. 6,000 to 7,000 parcels per hour, for example, and diverted to chutes that can hold the parcels for a complete route of a delivery vehicle.

With these procedures, it is appropriate for the parcels for the individual delivery routes to be provided at a pick-up point and then manually loaded into the parcel delivery vehicle by the delivery staff for the respective delivery route.

This process is labor-intensive and time-consuming, so there is a great need for further automation.

### SUMMARY

The invention is based on the task of providing a system for the automatic loading of parcel delivery vehicles and a parcel delivery vehicle suitable for the system, so that the loading process of parcel delivery vehicles can be further automated and accelerated.

According to the invention, this task is solved by a system and a parcel delivery vehicle according to the independent claims.

Advantageous further embodiments of the invention are the subject of the dependent claims.

The invention relates to a system for automatically loading parcels provided in a delivery depot at a pick-up point for a delivery tour onto parcel delivery vehicles. Several of the parcels are transported in the delivery depot and fed to the pick-up point as individual parcels.

In this application, parcels are understood to be any physical objects that can be transported and preferably do not exceed certain dimensions and/or a certain weight.

This includes everyday items such as consumables or food as well as technical items and equipment. The parcels are unpackaged items, packaged items and repackaged items, whereby in the case of packaged and repackaged items, the parcel includes the packaging or outer packaging and the item packaged in it.

The pick-up point is the position at which the individual parcels assigned to a delivery route are removed from a stream of parcels passing on a roller conveyor, or from a roller container assigned to an individual delivery route or a chute assigned to an individual delivery route or a conveyor belt assigned to an individual delivery route individual parcels are picked up.

The system according to the invention is characterized in that the individual parcels are picked up at the pick-up point by means of a pick-up unit, transported to the parcel delivery vehicle by means of a transport unit and brought into storage positions of the storage unit of the parcel delivery vehicle by means of a loading unit, and in that the system has a control component which is set up in such a way that it controls the loading process of a parcel delivery vehicle by the interaction of the pick-up unit, transport unit and loading unit and stores information on the storage of each parcel and the storage position of each parcel in the storage device and transmits the information on the position of each parcel in the storage device, transport unit and loading unit and stores information about the storage of each parcel and the storage position of each parcel in the storage unit and makes the information about the position of each parcel in the storage unit accessible to a delivery person by transmitting it to the parcel delivery vehicle or a delivery terminal upon reaching a handover location for the respective parcel prior to a handover of the parcel.

The individual parcels are stored in storage positions in the storage unit, taking into account the parcel identification characteristics of the individual parcels.

According to the invention, the pick-up unit, the transport unit and the loading unit can be designed as separate devices or designed in such a way that two of these devices or all three devices are realized in one device.

The system according to the invention further comprises a parcel delivery vehicle for handing over a plurality of parcels to a plurality of recipients at different handover points along a delivery route, wherein the parcel delivery vehicle is equipped with storage units for storing the parcels, which storage units have a plurality of storage positions and are arranged such that at least one loading unit has access to each storage position in such a way that the loading unit can transfer parcels into the storage position of the storage unit or remove parcels therefrom.

An appropriate further development of the invention is characterized in that the parcel delivery vehicle has a loading space which has storage units on the side walls which can be loaded with parcels. Side walls are the walls of the loading space, the length of which extends in the normal direction of travel of the parcel delivery vehicle.

A particularly advantageous embodiment of the invention provides for the side walls of the loading space to be opened before the parcels are stored in the storage unit.

An appropriate further development of the invention is characterized by the fact that the side walls of the load compartment are opened by sliding doors.

A particularly advantageous embodiment of the invention provides for the side walls of the load compartment to be opened by sliding roller doors.

An appropriate further development of the invention is characterized by the fact that the loading space of the parcel delivery vehicle is completely or partially opened at the rear for loading in a delivery depot.

With partial opening, the opening is wide enough to allow the transport units to enter and exit the load compartment.

In a preferred embodiment, the storage unit is set up so that it can be pulled out or moved out of the loading space of the parcel delivery vehicle. The storage positions are accessible not only from the center aisle, but also from the outside, and transport units can transport the parcels to both sides simultaneously for storage in the storage positions.

Alternatively, it is possible for the storage unit to be pulled apart (widened) after it has been pulled out or moved out of the loading space of the parcel delivery vehicle. The widening is preferably designed in such a way that the storage positions on both sides of the storage unit can be filled with parcels simultaneously through the central aisle.

An appropriate further development of the invention is characterized by the fact that the loading space of the parcel delivery vehicle is designed so that it can be separated from the mobile part of the vehicle.

An advantageous further development of the invention is characterized by the fact that during a stay of the parcel delivery vehicle in the area of the delivery depot, the following data elements are transmitted to the parcel delivery vehicle and/or to a delivery terminal for the parcels stored in the storage positions of a storage unit of the parcel delivery vehicle: at least one parcel identification characteristic that is suitable for enabling reliable identification of a respective parcel, information identifying the storage position within the storage unit of the parcel delivery vehicles for the storage of the respective parcel, and address and contact details of an intended recipient of the parcel.

An appropriate embodiment of the invention provides for the individual parcels to be rotated prior to their storage in storage positions so that they have a defined orientation.

An advantageous further development of the invention is characterized by the fact that the individual parcels are rotated during a stay on a transfer platform of a transport unit.

The system according to the invention provides for the storage of the individual parcels in the storage positions taking into account parcel identification characteristics of the individual parcels.

A parcel identification characteristic is a unique data element that is virtually assigned to the parcel and enables its reliable identification, in particular its unique identification. The reliable identification can relate to one or more process steps or to the entire logistics process from the delivery of a parcel to the output of the parcel. It is particularly advantageous that the parcel identification characteristic relates to the entire logistics process, but the invention also includes the use of the parcel identification characteristic in fewer process steps than the overall process.

A parcel identification characteristic preferably includes one or more characteristics which, alone or in combination with each other and/or in combination with information about one or more processing operations of a parcel, allow reliable identification of the parcel. Parcel identification characteristics are, for example: Package identification codes; Product codes; Shipper identification features; Consignor identification features; Recipient identification features; Weight of the parcel; Dimensions of the parcel; Form of the parcel; Image of the parcel, including an image of the parcel taken by a camera unit.

The use of parcel identification characteristics is also advantageous in the further processing of parcels.

According to the invention, the pick-up unit is a device that is set up to pick up parcels of different shapes and sizes at the pick-up point and transfer them to a transport unit. The pick-up unit is preferably a robot which can be controlled by the control component and which can be designed as a stationary gripper arm or rail-guided or freely movable.

It is appropriate to equip the robot with gripper arms. Preferably, robot tools, preferably gripper systems, are attached to the gripper arms, in particular one or more suction grippers, which are also called vacuum grippers. The gripper systems known from DE 198 17 426 A1, in particular vacuum gripper systems, are particularly preferably adapted for this purpose. In particular, it is advantageous to use the measures described in this publication for monitoring the gripping process, including a force sensor. This enables corrections to be made if parcels are gripped incorrectly, as forces outside a tolerance range can be measured and used to vary the control of the gripping process.

It is also appropriate to equip the gripper arms with one or more sensor modules, in particular at least one force sensor, in order to measure the force on the parcel to be lifted. Furthermore, the use of position sensors that are suitable for measuring a relative position or a distance between the parcel and the gripper or for determining the start and end points of a movement is advantageous.

Preferably, a flexible gripping device is used to pick up the parcels, which is shown, for example, in DE 20 2007 013 673 U1. This gripping device has a gripper with a multi-link frame, which is adapted for the present invention in such a way that the best possible adaptation to variable dimensions (geometries) of the parcels is made possible.

If a freely movable robot is used as the pick-up unit, it can also take over the functions of the transport unit and the loading unit and transport the individual parcels to the parcel delivery vehicle after pick-up at the pick-up point and store them in a storage position there. In one embodiment of the invention, such a robot additionally has a transfer platform for safely transporting the individual parcels. In accordance with the invention, the transfer platform can also be designed in such a way that several parcels can be transported on it at the same time.

The transport unit according to the invention is a mobile device which is set up to take one or more individual parcels of different shapes and sizes from the pick-up unit and to transport them to or into the parcel delivery vehicle under the control of the control component. The transport unit is preferably set up to transport a single parcel. According to the invention, the transport unit can be guided on rails or other guide means or be freely movable.

Preferably, the transport unit according to the invention has a transfer platform on which one or more individual parcels can be stored during transportation by the transport unit. In a preferred embodiment, the transfer platform of the transport unit is height-adjustable. In addition, it is preferred that the transfer platform of the transport unit is rotatable. The transfer platform also preferably has a conveyor belt for moving parcels deposited on it. It is advantageous if, in particular, light barrier sensors are used to check whether the parcel is completely on the transfer platform and ready for transport or has been completely transferred from the transfer platform during handover of a parcel to and/or from the transfer platform.

According to the invention, the conveyor belt of the preferably height-adjustable transfer platform of the transport unit can be used to transfer a parcel, in particular to the transfer platform and/or from the transfer platform to a storage position of a parcel delivery vehicle. Preferably, light barrier sensors are used to check whether, upon handover of a parcel to the transfer platform, the parcel is complete and ready for transportation on the transfer platform or has been completely transferred from the transfer platform to a storage position. This embodiment of the transport unit is therefore also suitable for use as a loading unit. In conjunction with a conveyor belt assigned to an individual delivery tour, this embodiment of the transport unit can, according to the invention, assume the function of both the pick-up unit and the loading unit.

According to the invention, the loading unit is a device which is set up to pick up parcels of different shapes and sizes on the parcel delivery vehicle and store them in a storage position of the storage unit of the parcel delivery vehicle. The loading unit is preferably a robot which can be controlled by the control component and which can be stationary or rail-guided or freely movable.

Analogous to the pick-up unit, it is appropriate to equip the robot with gripper arms. Preferably, robot tools, preferably gripper systems, are attached to the gripper arms, in particular one or more suction grippers, which are also called vacuum grippers. The gripper systems known from DE 198 17 426 A1, in particular vacuum gripper systems, are particularly preferably adapted for this purpose. In particular, it is advantageous to use the measures described in this publication for monitoring the gripping process, including a force sensor. This enables corrections to be made if parcels are gripped incorrectly, as forces outside a tolerance range can be measured and used to vary the control of the gripping process.

It is also appropriate to equip the gripper arms with one or more sensor modules, in particular at least one force sensor, in order to measure the force on the parcel to be lifted. The use of position sensors that are suitable for measuring a relative position or a distance between the parcel and the gripper or for determining the start and end points of a movement is also advantageous.

Preferably, a flexible gripping device is used to pick up the parcels, which is shown, for example, in DE 20 2007 013 673 U1. This gripping device has a gripper with a multi-link frame, which is adapted for the present invention in such a way that the best possible adaptation to variable dimensions (geometries) of the parcels is made possible.

If a freely movable robot is used as the loading unit, it can also take over the functions of the transport unit and the pick-up unit in the same way as described above for the pick-up unit and transport the individual parcels to the parcel delivery vehicle after picking them up at the pick-up point and store them in a storage position there.

In an alternative embodiment of the invention, the function of the loading unit as described above is performed by a correspondingly equipped transport unit.

The control component of the system according to the invention can be designed in such a way that it controls as many or even all of the processing operations of the parcels as possible. However, it is also possible for the control component to control only individual processing operations described in this application. According to the invention, the control component controls at least the loading process of a parcel delivery vehicle through the interaction of the pick-up unit, transport unit and loading unit. According to the invention, this ensures that the storage of the parcels in storage positions of a storage unit of the parcel delivery vehicles is carried out quickly and reliably. A further advantage is that the storage in the storage positions of the storage unit of the parcel delivery vehicles can be carried out without the use of sensor devices or other detection means in the parcel delivery vehicles.

According to the invention, a data record is transmitted to the parcel delivery vehicle and/or a delivery terminal immediately after the storage of parcels in a parcel delivery vehicle in the delivery depot has been completed, preferably while the parcel delivery vehicle is still present in the area of the delivery depot, under the control of the control component. The delivery terminal is a communication device that can be used for voice and data communication regardless of location, preferably a handheld scanner, a notebook, a tablet, a smartphone, a smart watch or data glasses (smart glasses). The contents of the data set are at least all relevant data required for the handover of the parcels now in the parcel delivery vehicle to the recipients. Preferably this is for each parcel stored in the parcel delivery vehicle in the area of the delivery depot:
The storage position within the parcel delivery vehicle's storage unit;
A parcel identification characteristic;
Address and contact details of an intended recipient of the parcel;

In addition, the data record may contain the following data for each parcel stored in the parcel delivery vehicle in the area of the delivery depot: size of the parcel, further parcel identification characteristics, contact details of the consignor, authentication features of the consignor, and authentication features of the recipient of the parcel.

The delivery of the large number of parcels takes place in particular as a direct handover of the parcels to a recipient at an individual handover point. A delivery person can be integrated into the process. The delivery agent is in particular a unit that is set up to cover distances between the delivery vehicle and the handover points for parcels and to carry out handovers of parcels to recipients or depositors. This is particularly preferably a suitably programmed robot, such as the humanoid robots from Boston Dynamics or four-legged robots such as the robot dog Spot, but possibly also humanoid delivery staff.

The term parcel delivery vehicle includes any vehicle that is set up to travel routes, in particular on public roads, and transport parcels along a delivery route to recipients of the parcels. The parcel delivery vehicle can be a conventional vehicle controlled by a delivery person, in particular a van or truck, or an autonomous or semi-autonomous vehicle.

A particularly preferred embodiment of the parcel delivery vehicle is characterized in that at least one transport path is located in the parcel delivery vehicle, whereby at least one transport unit can move along the transport path so that, using the transport unit, it is possible to transport individual parcels to storage positions of the parcel delivery vehicle, and in that the transport of the parcels by the transport units within the parcel delivery vehicle can be controlled taking into account the storage positions assigned to the respective parcels on the basis of the parcel identification characteristics.

An advantageous further development of the invention is characterized by the fact that individual parcels can also be transferred out of storage positions of the storage unit of parcel delivery vehicles by the transport units

In a particular embodiment, the storage positions of the storage unit of the parcel delivery vehicles according to the invention can be designed like lockers.

Handover points are places where parcels can be handed over to recipients. Joint handover points are places where handovers of several parcels to several recipients can take place. Individual handover points are places where the delivery of one or more parcels to a single recipient can take place.

The invention relates in particular to handover methods in which at least some of the handovers of parcels take place at locations along a delivery route. These are in particular individual handover points.

Preferably, the system according to the invention is used when individual handover points are to be approached in succession by a parcel delivery vehicle and deliveries of parcels are carried out there.

For the application of the system according to the invention, it is advantageous if at least one means for transferring the parcels to a transfer unit and at least one means for controlling the transfer unit are present in the area of the distribution center and/or delivery depot, so that the transfer unit can be controlled in such a way that parcels intended for delivery on a specific delivery route are transported to a pick-up point assigned to this delivery route.

For the application of the system according to the invention, it is advantageous if a delivery depot for parcels is provided, which is characterized in that it contains means for transporting the parcels, that it contains transfer units for transferring the parcels and for discharging the parcels to the pick-up points.

In the context of the present application, depositors are entities that hand over or can hand over parcels or other items to a logistics system. Both natural persons and technical units can be depositors in the context of the present application. Natural persons or technical units that hand over parcels to the logistics system for a transportation process are also referred to as shippers in the context of the present application. In particular, shipper refers to depositors who instruct a transportation of parcels, in particular including a pick-up, to a recipient. The present application includes embodiments in which the depositors of parcels are shippers, with.

Recipients within the meaning of the invention are units to which the logistics system transfers or can transfer parcels as the final processing step. Both natural persons and technical units can be recipients in the context of the present application.

Further advantages, special features and appropriate further embodiments of the invention are apparent from the sub-claims and the following illustration of preferred embodiments with reference to the figures.

### BRIEF DESCRIPTION OF THE DRAWINGS

FIG. 1 is a schematic representation of a part of the loading process according to one embodiment of the invention;

FIG. 2 is a principle representation of a part of the loading process according to a further embodiment of the invention;

FIGS. 3a, 3b, 3c are schematic representations of the storage unit of a parcel delivery vehicle according to the invention;

FIG. 4 is a detailed view of a storage position designed as a locker;

FIG. 5 is a parcel delivery vehicle according to the invention;

FIG. 6a is an advantageous compartment configuration of a shelf according to the invention;

FIG. 6b is an advantageous compartment configuration of a shelf according to the invention;

FIG. 6c is an advantageous compartment configuration of a shelf according to the invention;

FIG. 6d is an advantageous compartment configuration of a shelf according to the invention;

FIG. 7 is a perspective view of a transport unit according to the invention;

FIG. 8 is a top view of a transport unit according to the invention;

FIGS. 9a and 9b show a perspective view of a transport unit according to the invention with a rotatable transfer platform;

FIG. 10 is a top view of one embodiment of a transfer unit;

FIG. 11 is a top view of a second embodiment of a transfer unit;

FIG. 12 is a top view of a third embodiment of a transfer unit

FIGS. 13, 13a and 13b are representations of a roller conveyor which can be used as a component of a distribution center and/or a transfer unit, in particular as a section of the conveyor belts shown in FIGS. 10 to 12;

FIG. 14 is a top view of a fourth embodiment of a transfer unit;

FIGS. 15a, 15b, 15c are alternative embodiments of a locker-like configuration of the storage positions;

FIG. 16 is a schematic representation of part of the loading process during loading through the fully or partially open rear wall of the parcel delivery vehicle;

FIG. 17 is a top view of a storage unit according to the invention;

FIG. 18 is a schematic representation of the loading of a storage unit extended from the parcel delivery vehicle from the side.

FIG. 19 is a schematic representation of the loading of a storage unit extended from the parcel delivery vehicle through the center, after widening; and

FIGS. 20, 20a, 20b, are principle representations of shelving systems for storage units according to the invention.

### DETAILED DESCRIPTION

### Introduction

As already described in the introductory part, the present application relates to a system for the automatic loading of parcel vehicles with objects having certain shape characteristics (rolls, cuboids, etc.), minimum dimensions, maximum dimensions, minimum weights and maximum weights as parcels, wherein the respective processing means can be adapted to the reference variables: Shape characteristics, minimum dimensions, maximum dimensions, minimum weights and maximum weights can be adapted. It is possible to process articles of daily use such as consumables or foodstuffs as well as technical articles and equipment as parcels, whereby, as also already described in the introductory section, the parcels can be unpackaged articles, packaged articles and repackaged articles, whereby in the case of packaged and repackaged articles the parcel comprises the packaging or outer packaging and the article packaged therein.

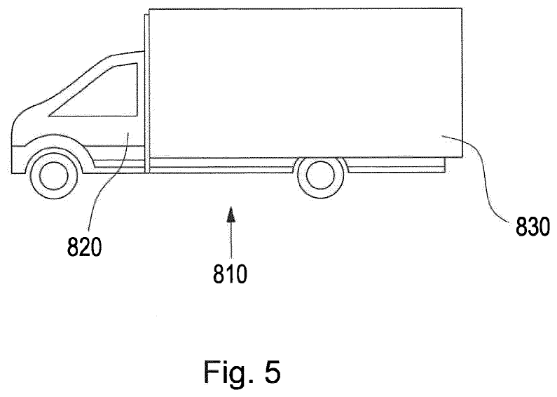

Preferred embodiments of the parcel delivery vehicles and their loading are shown in FIGS. 5, 6a, 6b, 6c, 6d, 10, 11, 12, 14, 15a-c, 16, 17, 18, 19 and 20.

Advantageous embodiments of the invention are explained below with reference to these figures.

### Control Component

The control component of the system according to the invention can be designed in such a way that it controls as many or even all of the processing operations of the parcels as possible. However, it is also possible for the control component to control only individual processing operations described in this application. According to the invention, the control component controls at least the loading process of a parcel delivery vehicle through the interaction of the pick-up unit, transport unit and loading unit.

Details of preferred embodiments of the control component and its interaction with components of a logistics system are shown below.

For the targeted distribution of parcels in the area of the delivery depot to the parcel delivery vehicles, parcel and line switching communication protocols are used and adapted to handle the distribution of parcels.

It is particularly advantageous to use telecommunication protocols for the control operations and/or for protocol operations, in particular packet-switched and circuit-switched telecommunication protocols and mechanisms for controlling parcel delivery, logistics and workflow management systems.

An advantageous further development of the system according to the invention provides that the control component stores and/or makes accessible further information assigned to the parcels as machine-readable data, in particular by using digital twins. An example of the further information includes dimensions, in particular the spatial dimensions of the parcel and/or the weight of the parcel, due date/time for delivery, penalties for late delivery, delivery costs, depositor and recipient information, material, fragility and parameters of the required transportation of the parcel, e.g. a refrigerated truck for goods that require refrigeration.

### Parcel Processing in Distribution Centers and Delivery Depots

Preferred configurations of sorting processes in distribution centers and delivery depots are explained below. The logistics system forwards information on parcel identification characteristics, which enable the parcels to be identified, as well as information on the intended transfer locations to network nodes of the logistics system.

The logistics system receives information on parcel identification characteristics, which enable the parcels to be identified, from preferably several sources of information, for example when the parcels are delivered by a recording means, by identification devices such as scanners and RFID readers in the area of distribution centers and delivery depots, in the area of transfer units.

The logistics system forwards the information on parcel identification characteristics, which enable the parcels to be identified, as well as information on the intended transfer locations for delivery to transfer units and/or via the control component of the system according to the invention to the parcel delivery vehicles and/or delivery terminals. Forwarding the information on the parcel identification characteristics both to the transfer units and to the parcel delivery vehicles and/or delivery terminals has the advantage that the storage of the parcels in storage positions of a storage unit of the parcel delivery vehicles takes place quickly and reliably. A further advantage of this appropriate embodiment is that storage in the storage positions of the storage unit of the parcel delivery vehicles can take place without the use of sensor devices or other detection means in the parcel delivery vehicles.

Network nodes of the logistics system are, in particular, components of the logistics system in which decisions are made about the processing of parcels. These are, for example, sorting processes that preferably take place in distribution centers for parcels. Examples of network nodes of the logistics system are preferably transfer units as well as the pick-up units, transport units, loading units and the parcel delivery vehicles and delivery terminals of the system according to the invention.

Here, the patent identification features are transmitted in such a way that the respective network nodes bring the parcels into the further transport process, taking into account the respective handover points.

### Brief Description of Loading Preparation and Storage

Preparing the parcel delivery vehicles for loading includes one, several or even all of the parcel processing operations described below:
Transfer of parcels from a distribution center to a delivery depot;
Separation of parcels in the distribution center or delivery depot;
Transport of the parcels to a pick-up point;

Individual, several or even all of these processing operations for the parcels are preferably carried out by transfer units.

In particular, these are processing operations in which several parcels are preferably transported directly one behind the other to the pick-up points and then stored in the parcel delivery vehicles using the system according to the invention. The parcels are stored in the parcel delivery vehicles by placing the parcels in storage positions of storage units of the parcel delivery vehicles.

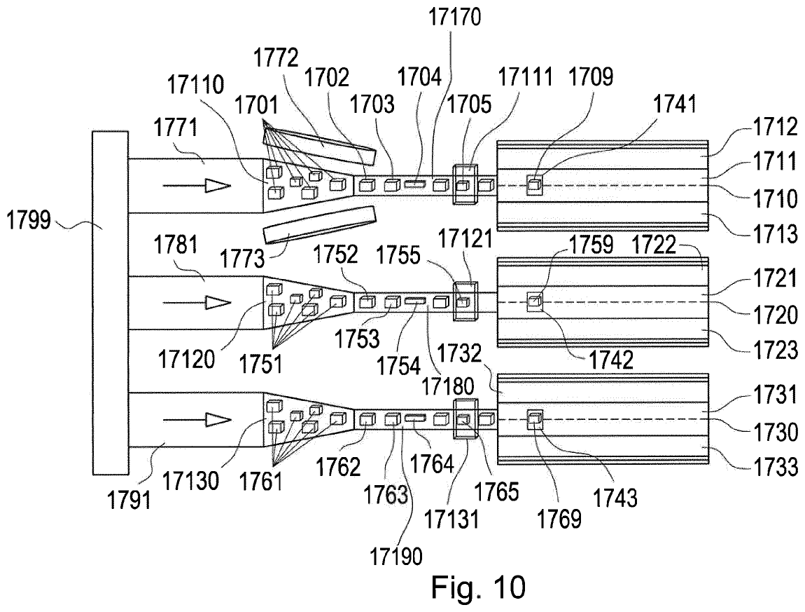

In order to carry out the storage of the parcels in the parcel delivery vehicles as quickly as possible with usage of the system according to the invention, it is appropriate to use transfer units, examples of which are shown in FIGS. 10, 11, 12 and 14.

### Transfer Unit

Transfer units within the meaning of the present application are devices which are designed to enable parcels to be transported to a pick-up point.

Another processing module that is controlled by the logistics system is a sorting module within the delivery depot, which preferably also serves to divert the parcels to the pick-up points.

Preferably, processing in the area of the transfer units includes autonomous separation and optimized alignment of the parcels for the loading process in storage positions of the storage units of the parcel delivery vehicles.

### Loading the Parcel Delivery Vehicles

The system according to the invention provides at least one pick-up unit, at least one transport unit and at least one loading unit as means for loading the parcel delivery vehicles, in particular for the storage of individual parcels in storage positions of the storage units of the parcel delivery vehicles and advantageously including parcel identification characteristics for the individual parcels.

Immediately after the storage of parcels in a parcel delivery vehicle in the delivery depot has been completed, a data record is transmitted to the parcel delivery vehicle and/or a delivery terminal under the control of the control component while the parcel delivery vehicle is still present in the area of the delivery depot. The data record contains at least all the relevant data required by the delivery agent for handover of the parcels now in the parcel delivery vehicle to the recipients.

Preferably, these are for each parcel stored in the parcel delivery vehicle in the area of the delivery depot:
The storage position within the parcel delivery vehicle's storage unit;
A parcel identification characteristic;
Address and contact details of the intended recipient of the parcel;

In addition, the data record can contain the following data for each parcel stored in the parcel delivery vehicle in the area of the delivery depot:
Size of the parcel
Further parcel identification characteristics
Contact details of the consignor
Authentication features of the consignor
Authentication features of the recipient of the parcel.

This means that the parcel delivery vehicles and the delivery staff can operate autonomously at their locations without permanent communication with the logistics system or the control component; i.e. all parcels in the parcel delivery vehicle can be delivered to the respective recipient on site.

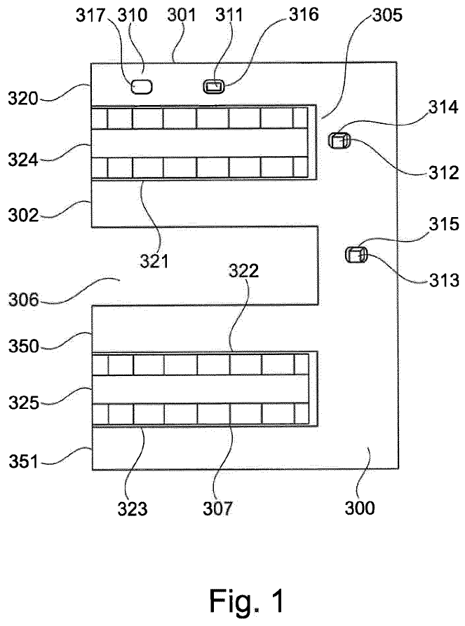

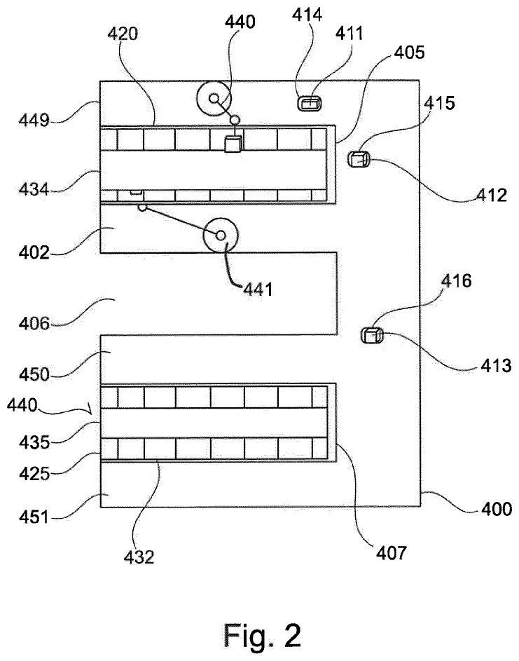

FIGS. 1 and 2 show components of a system according to the invention for the automatic loading and/or unloading of parcel delivery vehicles.

Devices for loading the parcel delivery vehicles have loading bays 305, 306, 325, 405, 406, 407. Parcel delivery vehicles 324, 325, 434, 435 are driven into the loading bays 305, 306, 307, 405, 406, 407 so that they can be loaded. The parcel delivery vehicles 324, 325, 434, 435 are loaded by means of transport units on which parcels can be transported to the storage positions of the parcel delivery vehicles 324, 325, 434, 435.

The transport units can preferably be moved in the area of the entire equipment for loading the parcel delivery vehicles, including loading bridges 302, 320, 350, 351, 402, 449, 450, 451.

The system preferably has a control component not shown here for reasons of simplification. The control component is arranged to control loading operations and/or unloading operations of parcel delivery vehicles 324, 325, 425, 434 by the interaction of the pick-up unit, transport unit and loading unit and to store information about the storage of each parcel and the location of each parcel in the storage unit and to transmit the information about the location of each parcel in the storage unit to the parcel delivery vehicle or a delivery terminal and to make it accessible to a delivery person upon reaching a handover location for the respective parcel prior to a handover of the parcel.

FIGS. 1 and 2 show a use of a plurality of transport units 314, 315, 316, 317, 414, 415, 416 for a transport of the parcels to the parcel delivery vehicles 324, 325, 425, 434. In a preferred embodiment, the transport units 314, 315, 316, 317, 414, 415, 416 also serve as loading units which can transfer parcels 311, 312, 313, 411, 412, 413 to storage positions of at least one storage unit 321, 322, 323, 420, 432.

Furthermore, in particular in the vicinity of the parcel delivery vehicles 324, 325, 425, 434, gripper arms 440, 441 can be arranged as loading units. The gripper arms may, for example, be part of robots and/or be movably mounted. Preferably, robot tools, preferably gripping systems, are attached to the gripper arms, in particular one or more suction grippers, which are also called vacuum grippers. For example, the gripper systems known from DE 198 17 426 A1, in particular vacuum gripper systems, are adapted for this purpose. In particular, it is advantageous to use the measures described in this publication to monitor the gripping process using a force sensor. This enables corrections to be made if parcels are gripped incorrectly, as forces outside a tolerance range can be measured and used to vary the control of the gripping process.

Furthermore, it is appropriate to equip the gripper arms with one or more sensor modules, in particular at least one force sensor, in order to measure the force on the parcel to be lifted, in particular the parcels 411, 412, 413. Furthermore, the use of position sensors that are suitable for measuring a relative position or a distance between the parcel and the gripper or for determining the start and end points of a movement is advantageous.

Preferably, a flexible gripping device is used to pick up the parcels, which is shown, for example, in DE 20 2007 013 673 U1. This gripping device has a gripper with a multi-link frame, which is adapted for the present invention in such a way that better adaptation to variable dimensions (geometries) of the parcels is made possible.

### Parcel Delivery Vehicle

FIG. 5 shows a parcel delivery vehicle 810 according to the invention. The parcel delivery vehicle 810 preferably has a driver's cab 820 and a loading compartment 830.

The invention also includes more complex parcel delivery vehicles, for example with devices for autonomous driving or semi-autonomous driving, whereby the driver's cab, for example, can be omitted, particularly in the case of autonomous driving.

The parcel delivery vehicle 810 preferably includes a local data terminal, not shown here, preferably a delivery terminal, which is arranged to receive, store and/or output data.

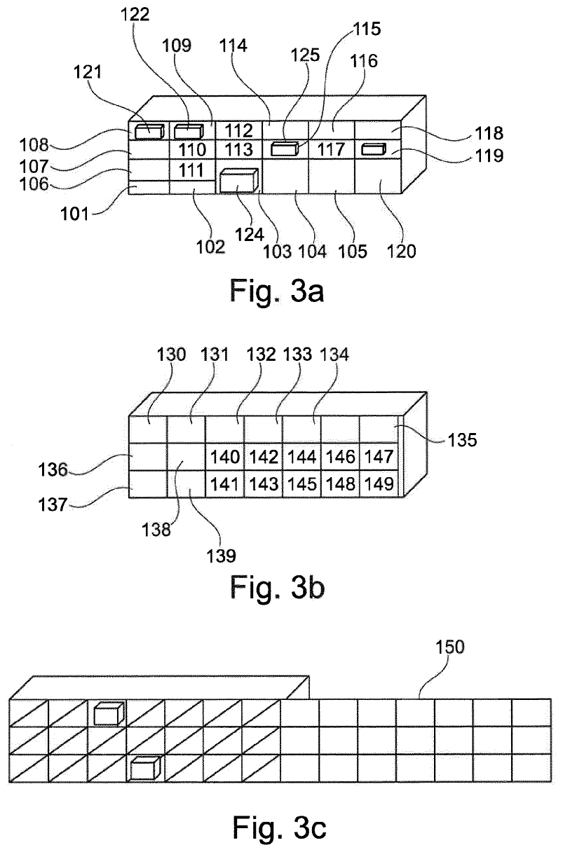

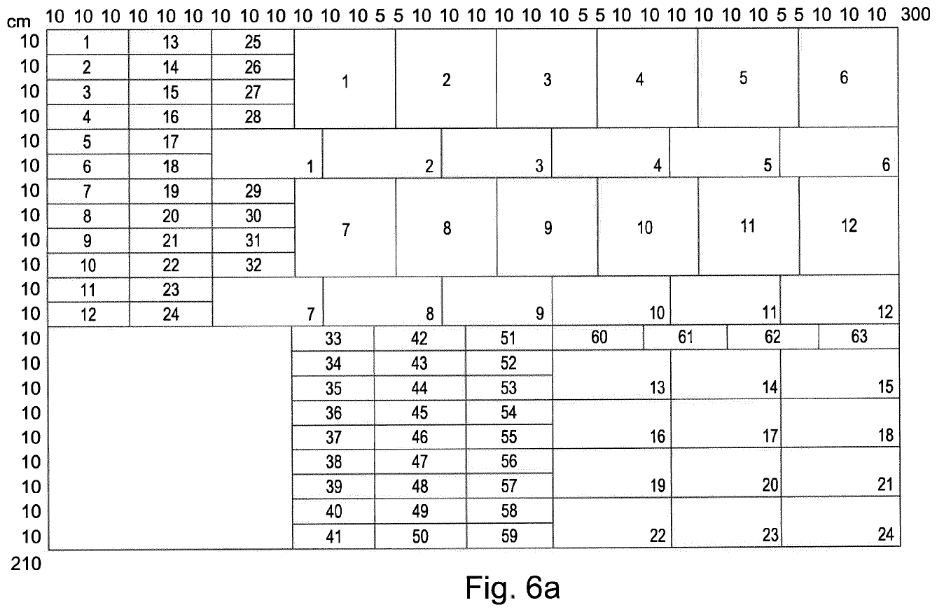

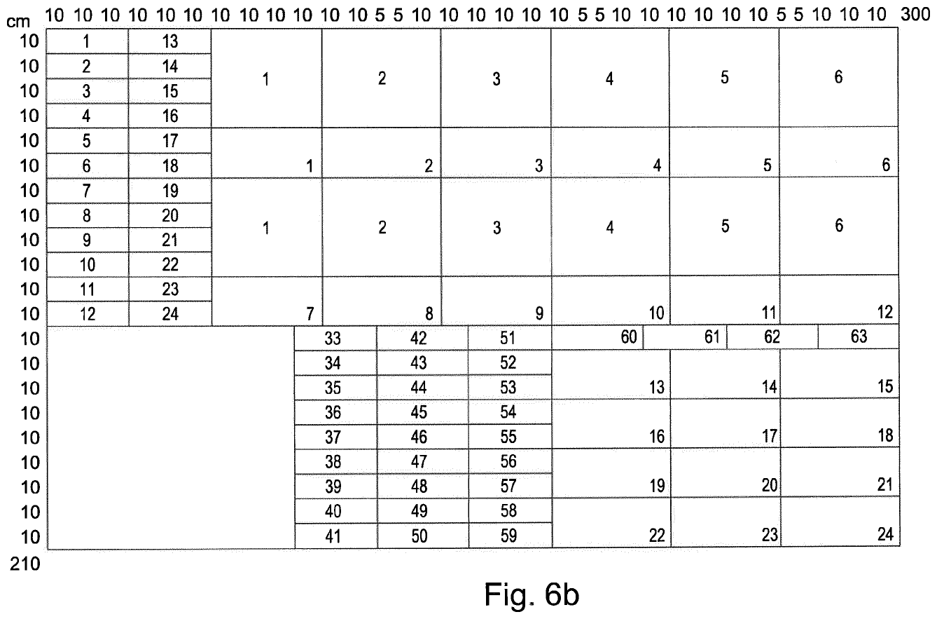

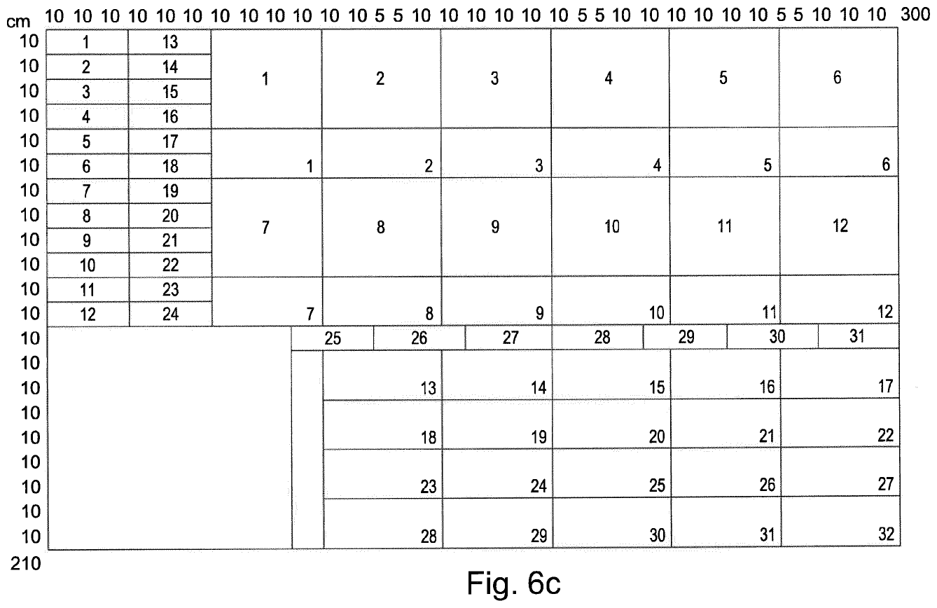

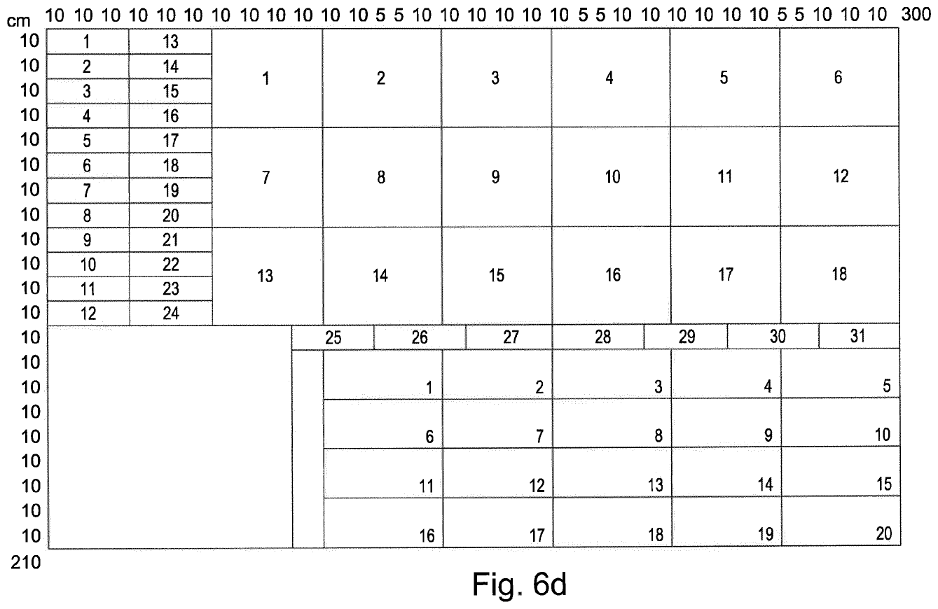

FIGS. 3a, 3b, 3c show in particular side views of the loading space 830. FIGS. 6a-6d show embodiments of the storage units. Here, FIG. 3a shows a one-sided external view of the open loading space 830 with storage positions 101, 102, 103, 104, 105, 106, 107, 108, 109, 110, 111, 112, 113, 114, 115, 116, 117, 118, 119, 120, preferably at least partially of different sizes, in part FIG. 3b shows the one-sided exterior view of the closed load compartment 830 and FIG. 3c shows the exterior view of the load compartment 830 analogous to 3b with an open outer wall formed as a sliding door 150.

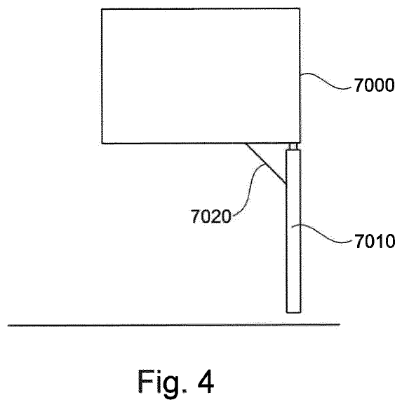

FIG. 4 shows a detailed view of a single locker 7000 of an embodiment similar to FIG. 3b, with open door 7010 and a spring and fixation 7020, which is designed to open the locker door 7010 at an angle of 90° for loading and preferably to close it again automatically after loading.

In the embodiments illustrated with reference to FIGS. 1, 2, 10-12, 14, 14, and 16-18, the loading space of the parcel delivery vehicle according to the invention has a particularly simple and appropriate structure with a central aisle.

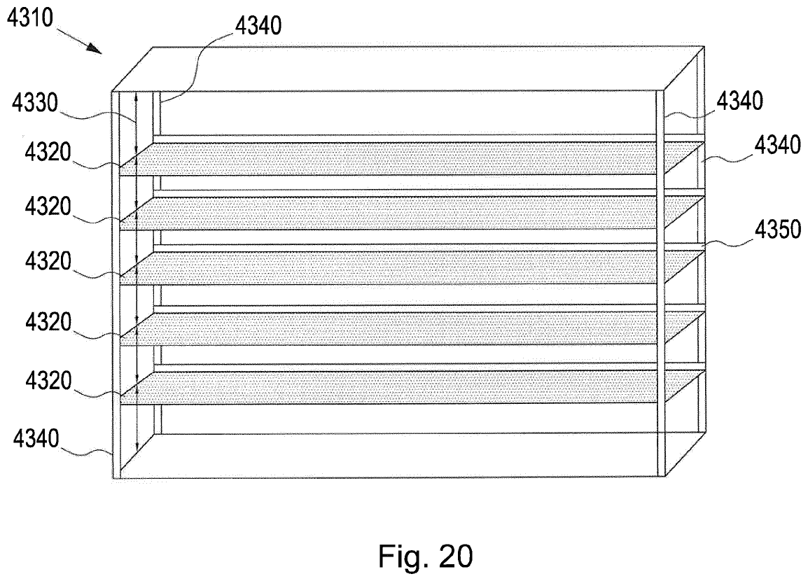

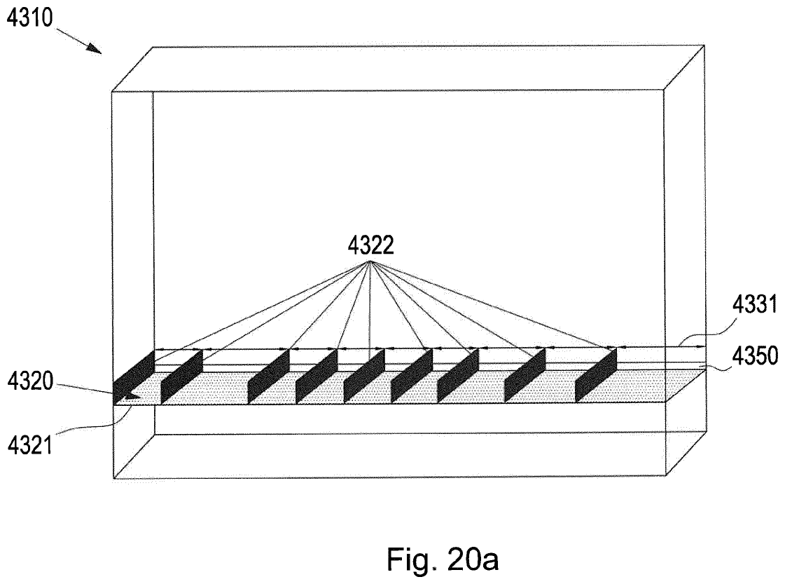

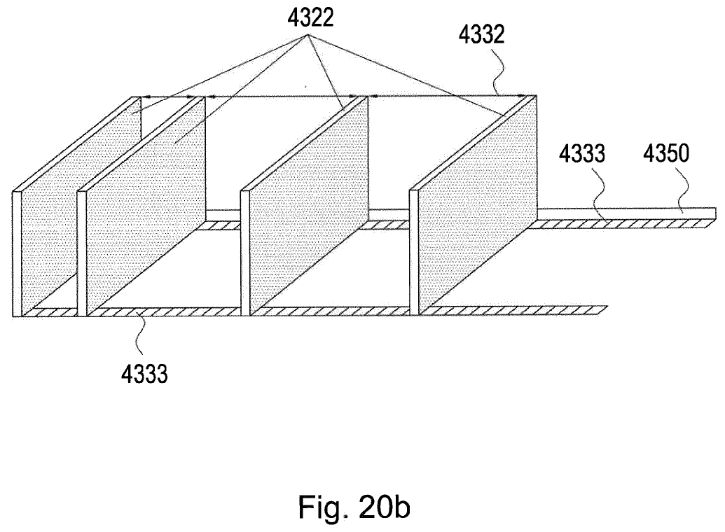

Shelves are arranged on the sides of the central aisles as storage units. Possible designs are shown in FIG. 20a-b 2020a (4310). (Of course, designs with other configurations of the storage positions are also possible).

FIGS. 6a-d each show an advantageous compartment configuration of a storage unit according to the invention; the storage units (shelving units), which are located inside parcel delivery vehicles for the storage of parcels, can have a fixed compartment configuration as in FIGS. 6a to 6d, e.g. in FIG. 6a with a total of 99 compartments in the layout with 63 compartments of size S (30 cm×10 cm×50 cm), 24 compartments of size M (35 cm×20 cm×50 cm) and 12 compartments of size L (35 cm×40 cm×50 cm), FIG. 6b with a total of 91 compartments in the division with 55 compartments of size S (30 cm×10 cm×50 cm), 24 compartments of size M (20 cm×40 cm×50 cm) and 12 compartments of size L (40 cm×40 cm×50 cm), FIG. 6c with a total of 75 compartments in the layout with 31 size S compartments (30 cm×10 cm×50 cm), 32 compartments of size M (20 cm×40 cm×50 cm) and 12 compartments of size L (40 cm×40 cm×50 cm) and FIG. 6d with a total of 69 compartments in the layout with 31 compartments of size S (30 cm×10 cm×50 cm), 20 compartments of size M (20 cm×40 cm×50 cm) and 18 compartments of size L (40 cm×40 cm×50 cm).

It is also advantageous to equip the loading compartments of parcel delivery vehicles with at least one gripper arm, not shown for reasons of simplification, preferably similar to the gripper arms used in pick-up units.

If necessary, by using a gripper arm in the loading compartments of the parcel delivery vehicles, one or more of the following processing operations can be carried out and/or facilitated:
Carrying out and/or facilitating the storage of parcels in the storage positions of the parcel delivery vehicle;
Carrying out and/or facilitating the removal of parcels from the storage positions of the parcel delivery vehicle.

In this embodiment, gripper arms in the parcel delivery vehicle function as the loading unit of the system according to the invention.

Preferably, robot tools, preferably gripper systems, are attached to the gripper arms, in particular one or more suction grippers, also known as vacuum grippers. For example, the gripper systems known from DE 198 17 426 A1, in particular vacuum gripper systems, are adapted for this purpose. In particular, it is advantageous to use the measures described in this publication to monitor the gripping process using a force sensor. This enables corrections to be made if parcels are gripped incorrectly, as forces outside a tolerance range can be measured and used to vary the control of the gripping process.

Furthermore, it is appropriate to equip the gripper arms with one or more sensor modules, in particular at least one force sensor, in order to measure the force on the parcel to be lifted, in particular the parcels 2101, 2151, 2161, 21201. Furthermore, the use of position sensors that are suitable for measuring a relative position or a distance between the parcel and the gripper or for determining the start and end points of a movement is advantageous.

Preferably, a flexible gripping device is used to pick up the parcels, which is shown, for example, in DE 20 2007 013 673 U1. This gripping device has a gripper with a multi-link frame, which is adapted for the present invention in such a way that better adaptation to variable dimensions (geometries) of the parcels is made possible.

### Transport Unit

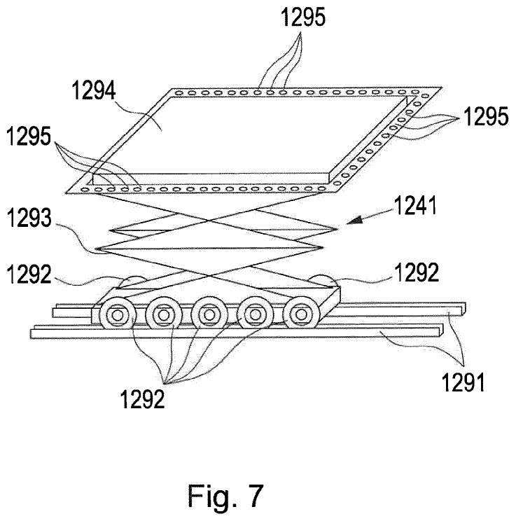

FIG. 7 shows a perspective view of a transport unit; transport units carry out the transportation of parcels from the pick-up point to the parcel delivery vehicle. According to the invention, the transport unit 1241 can be guided on rails 1291 by means of wheels 1292, but the transport units can also be freely movable.

The transport unit 1241 according to the invention can have a height-adjustable device 1293, which is preferably in the form of a hinge. The height-adjustable device 1293 is used for the height-adjustable mounting of a transfer platform 1294. The transfer platform 1294 preferably has a conveyor belt for transporting parcels. It is advantageous if, in particular by means of light barrier sensors 1295, it is checked whether, upon handover of a parcel to and/or from the transfer platform 1294, the parcel is completely on the transfer platform 1294 and ready for transport or has been completely handed over from the transfer platform 1294.

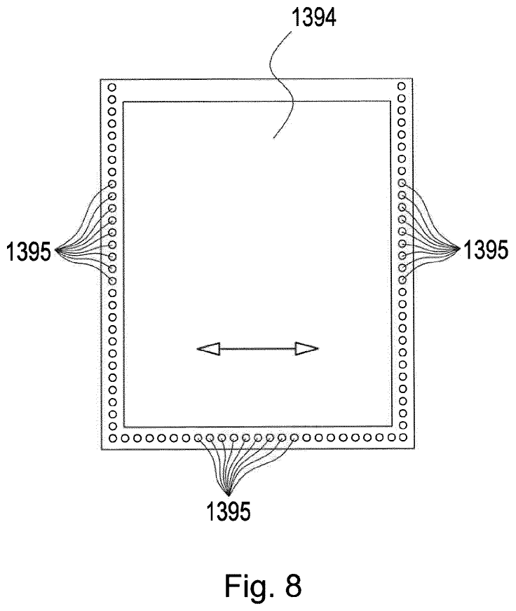

FIG. 8 shows a top view of an embodiment of a transport unit according to the invention; the transfer platform 1394 preferably has a conveyor belt for transporting parcels. The conveyor belt can be used to transfer a parcel, in particular to the transfer platform and/or from the transfer platform to a storage position of storage units of a parcel delivery vehicle. The light barrier sensors 1395 are used to check whether, upon handover of a parcel to the transfer platform 1394, the parcel is completely on the transfer platform 1394 and ready for transportation or has been completely transferred from the transfer platform 1394 to a storage position. This embodiment of the transport unit is thus also suitable for functioning as a loading unit.

In advantageous embodiments of the invention, parcel delivery vehicles are configured such that transport units move and/or are controlled in them such that they can perform and/or facilitate individual several or all of the subsequent processing operations:
Carrying out and/or facilitating the storage of parcels in the storage positions of the parcel delivery vehicle;
Carrying out and/or facilitating the removal of parcels from the storage positions of the parcel delivery vehicle

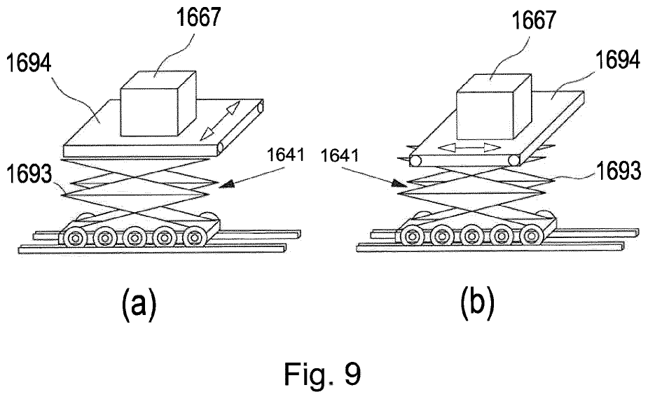

The transport unit 1641 has a height-adjustable device 1693, which is exemplarily designed in the form of a hinge. The height-adjustable device 1693 is used for the height-adjustable mounting of a transfer platform 1694. The transfer platform 1694 preferably has a conveyor belt for transporting parcels, for example the parcel 1667 shown as an example in FIG. 9a.

The transfer platform 1694 is preferably rotatably mounted. This makes it easier, for example, for the transfer platform 1694 to act as a pick-up unit at the pick-up point and, in particular, to pick up parcels from a conveyor belt and/or—preferably after rotation of the transfer platform 1694—to transfer parcels to storage positions of storage units of the parcel delivery vehicles and thus also to take over the function of the loading unit.

### Loading Preparation

From the sorting process, the parcels intended for delivery by parcel delivery vehicles are automatically identified, ejected, preferably separated and preferably transported to the pick-up position of a parcel delivery vehicle by means of a conveyor belt.

If the parcels have not already been separated beforehand, it is advantageous to provide a parcel separator for separating the parcels before the pick-up position of the delivery depot, which lines up the parcels individually and one behind the other in the direction of the pick-up point before the pick-up position.

Preferably, the parcel separators are designed with a gradual narrowing and preferably configured by means of forward-pulling side belts in such a way that the parcels are separated.

FIGS. 10, 11, 12, 13, 13a and 13b provide a more detailed description of these processes. In the embodiments of the invention illustrated in FIGS. 10, 11, 12, 13, 13a, and 13b, parcels are separated in the area of conveyor belts and fed to the pick-up point.

FIG. 10 shows a fully automatic design of a transfer unit with gradual narrowing and forward-pulling side belts.

As soon as the loading compartments of the delivery vehicles 1711, 1721 and 1731 are completely or partially open at the rear for loading in a delivery depot, so that the transport units can enter and exit the loading compartment, the transport units 1741, 1742 and 1743 enter the loading compartments of the delivery vehicles. For loading the delivery vehicles, the telescopic conveyor belts 17170, 17180, 17190, which convey the parcels directly from the chutes 1771, 1781 and 1791, are extended to the loading compartments of the delivery vehicles. The end of the respective telescopic transport belts acts as a pick-up point for the transport units 1741, 1742 and 1743. Here, the transport units 1741, 1742 and 1743, which in this embodiment preferably also perform the function of the pick-up unit and the loading unit, pick up the parcels 1709, 1759 and 1769 and store them in the storage units 1712, 1713, 1722, 1723, 1732 and 1733 of the delivery vehicles 1711, 1721 and 1731.

The chutes 1771, 1781, 1791 are configured by gradual narrowings 17110, 17120 and 17130, preferably equipped with a conveyor belt, and, for simplification reasons, only once shown, forward-pulling side belts 1772 and 1773, so that a separation of the parcels 1701-1709, 1751-1759, 1761-1769 results.

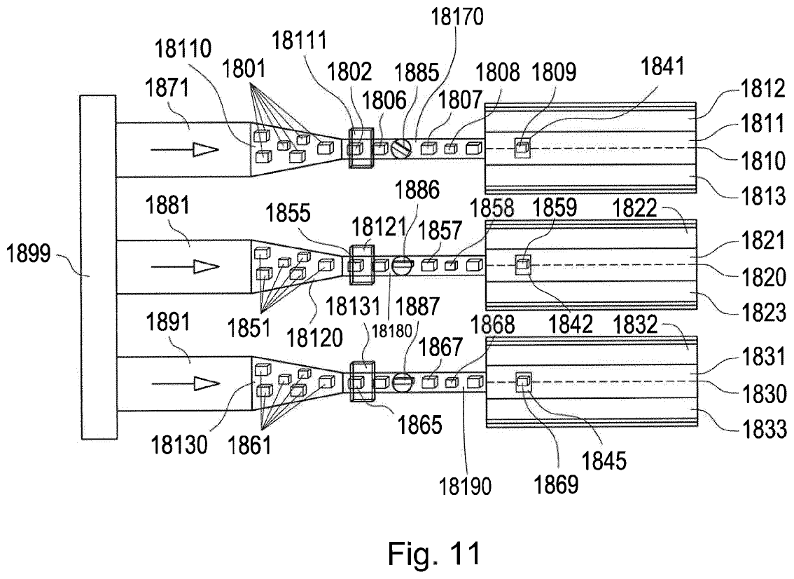

FIG. 11 shows a fully automatic design of a transfer unit with alignment turntable and suspension. As soon as the loading compartments of the delivery vehicles 1811, 1821 and 1831 are completely or partially open at the rear for loading in a delivery depot, so that the transport units can enter and exit the loading compartment, the transport units 1841, 1842 and 1843 enter the loading compartments of the delivery vehicles. For loading the delivery vehicles, the telescopic conveyor belts 18170, 18180, 18190, which transport the parcels directly from the chutes 1871, 1881 and 1891, are extended to the loading compartments of the delivery vehicles. The end of the respective telescopic transport belts acts as a pick-up point for the transport units 1841, 1842 and 1845. Here, the transport units 1841, 1842 and 1843, which in this embodiment preferably also perform the function of the pick-up unit and the loading unit, take over the parcels 1809, 1859 and 1869 and store them in the storage units 1812, 1813, 1822, 1823, 1832 and 1833 of the delivery vehicles 1811, 1821 and 1831.

The chutes 1871, 1881, 1891 are configured via a gradual narrowing 18110, 18120, 18130 as well as forward-pulling side belts not shown for reasons of simplification and additionally via turntables and springs 1885, 1886, 1887 in such a way that the parcels are separated. In addition, the telescopic conveyor belts 18170, 18180, 18190 are equipped with a turntable 1885, 1886, 1887 with several suspensions, and a 6-sided scanner 18111, 18121, 18131 is arranged above the telescopic conveyor belts 18170, 18180, 18190 at the beginning of the telescopic conveyor belts 18170, 18180, 18190. This transfer unit can be operated in two variants:
After scanning by the 6-sided scanner 18111, 18121, 18131, the parcel is transported further and a “flat-rate adjustment” is carried out, i.e. the parcel is automatically centered by springs permanently pressing on both sides.
after scanning by the 6-sided scanner 18111, 18121, 18131, the parcel is conveyed further; the data on how the parcel is positioned on the conveyor belt is forwarded by the 6-sided scanner 18111, 18121, 18131 to a control device, which may be part of the control component, whereby the control component moves the springs according to the position of the parcel (i.e. each spring individually), so that the parcel is also positioned centrally thereafter.

Although the individual parcels 1701, 1702, 1703, 1704, 1705, 1751, 1752, 1753, 1754, 1755, 20 1761, 1762, 1763, 1764, 1765 differ considerably in terms of dimensions, volume and shape, this ensures that the parcel is always positioned exactly in the middle of the conveyor belt, which is advantageous for handover to the transport unit. At the same time, the alignment turntable can ensure that the parcels are stored in the storage unit with the shortest side in the longitudinal direction of the loading space to save space.

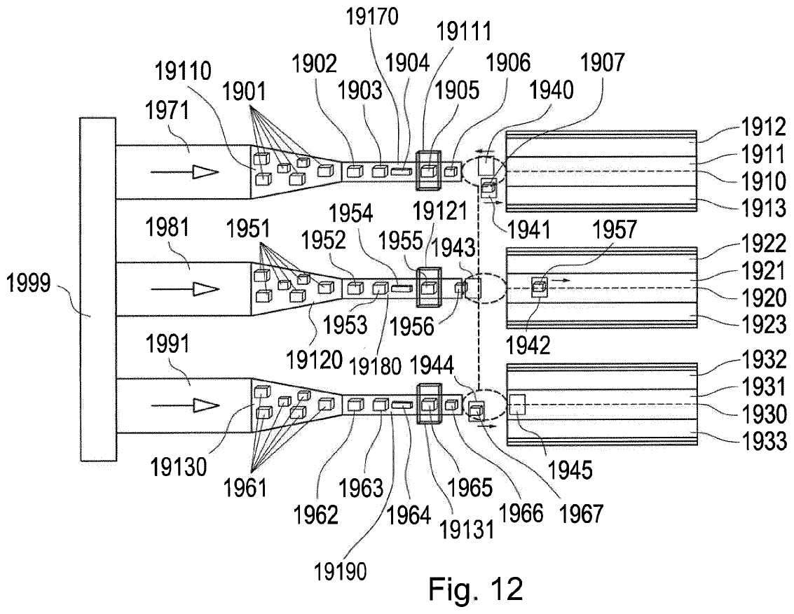

FIG. 12 shows a transfer unit similar to that shown in FIG. 11 with the use of two or more transport units. To speed up the loading of a parcel delivery vehicle, two or more transport units can alternatively be used for loading a parcel delivery vehicle.

In contrast to loading a parcel delivery vehicle with one transport unit, when loading with two or more transport units 1940, 1941, 1942, 1943, 1944, 1945, the transport units travel to the conveyor belt to pick up a parcel. For the route from the parcel delivery vehicle to the conveyor belt, a guide rail can be used if necessary, which docks seamlessly onto the guide rail of the parcel delivery vehicle.

However, freely movable transport units that are controlled by the control component are more advantageous. In this case, a guide rail is not required.

During usage of a guide rail, the “empty” transport unit moves, for example, over the right-hand side of the ring of the guide rail to the conveyor belt from the perspective of the parcel delivery vehicle in order to pick up a parcel, preferably with the help of a pick-up unit (not shown for reasons of simplification). Parallel to this, a second transport unit is then waiting on the left-hand side of the ring, already loaded with a parcel from the conveyor belt. As soon as the empty transport unit has left the parcel delivery vehicle and moves to the conveyor belt, the transport unit loaded with a parcel moves into the parcel delivery vehicle for loading.

In a preferred embodiment of the invention, the transport unit also performs the function of the loading unit. However, the parcels can also be moved to a storage position by a loading device arranged in the loading space of the parcel delivery vehicle.

It is advantageous if the door of the parcel delivery vehicle, which occupies the entire rear of the parcel delivery vehicle, can be opened wide enough to allow the parcel delivery vehicle to be maneuvered directly up to the loading ramp without leaving any distance to it.

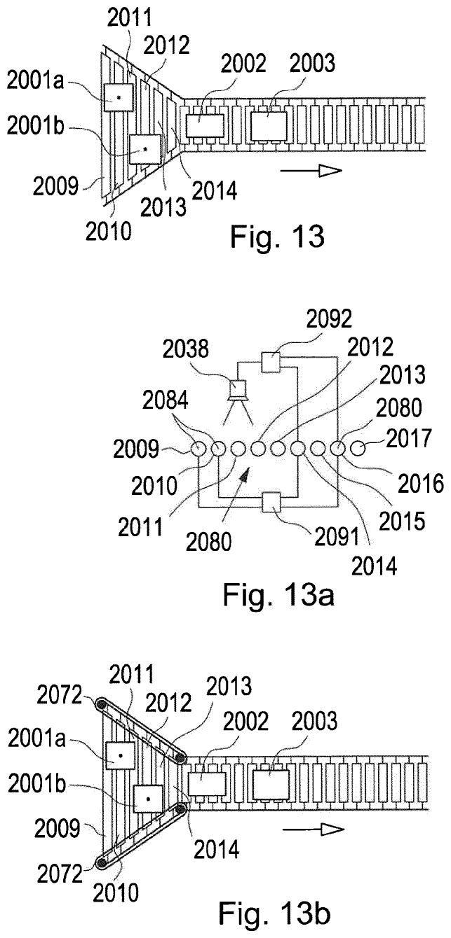

FIG. 13 shows a top view of a roller conveyor that can be used as part of a transfer unit, in particular as a conveyor belt.

FIGS. 13, 13a and 13b illustrate advantageous embodiments for separating parcels both in delivery depots, as shown in FIGS. 10-12, and on main conveyor belts of distribution centers.

The parcels 2001a and 2001b, 2002 and 2003 are generally conveyed forwards by individual elements 2009-14 of a roller conveyor or by equivalent technical devices, in FIGS. 13 and 13b to the right. However, each individual element 2009-14 of the roller conveyor can also be rotated against the general direction of flow, i.e. to the left in FIGS. 13 and 13b. In addition, the speed of each individual element can be varied. Thus, in the case of not yet sufficiently separated parcels such as 2001a and 2001b, the upper parcel 2001a can be slowed down and the lower parcel 2001b can be accelerated, so that a complete separation of the parcels 2001a and 2001b results by the time the roller conveyor tapers after individual element 2014. Technically, this is achieved by the individual elements 2009 and 2010 rotating to the left and the individual elements 2012 and 2013 rotating to the right at an accelerated rate compared to the normal speed of the individual elements, while individual element 2011 does not rotate at all for a brief moment.

The separation process can also be supported by lateral belts 2072 as shown in FIG. 13b. The lateral belts 2072 can be rotated in both directions. The lower parcel 2001b can be moved forward not only by an accelerated movement of the individual elements 2012 and 2013, but also by a forward movement of the lower lateral belt 2072, which supports the separation process.

FIG. 13a shows a cross-section of a section of the roller conveyor shown in FIGS. 13 and 13b. The roller conveyor shown as an example in FIG. 13a has cylindrical rollers 2009, 2010, 2011, 2012, 2013, 2014, 2015, 2016, 2017. The rollers are rotatably mounted via exemplary rotational axes 2084 and 2080.

Individual rollers, in the case shown the rollers 2011, 2012, 2013, 2017, do not have their own drive, but are rotatably mounted around their respective axis of rotation, preferably with a corresponding low-friction storage unit, for example a ball bearing or a shaft bearing.

The rollers 2009, 2010, 2014, 2016 are each preferably individually drivable via a motor not shown for reasons of simplification. In particular, the motor driving each of the rollers 2009, 2010, 2014, 2016 is set up in such a way that it can cause the rollers 2009, 2010, 2014, 2016 to actively rotate both clockwise and counterclockwise, so that parcels can be specifically accelerated or specifically decelerated in the areas in which they rest on the respective roller.

The motors which drive the rollers 2009, 2010, 2014, 2016 are controlled by a controller 2091, which can be part of the control component according to the invention, wherein the controller 2091 can take into account evaluation signals of a detection unit 2092 for positions of parcels 2001a, 2001b, 2002, 2003. For this purpose, the detection unit 2092 cooperates with at least one and/or a camera device 2038 for detecting the positions of the parcels 2001a, 2001b, 2002, 2003.

As previously explained with reference to FIG. 13, the parcels 2001a and 2001b lie close to each other on the conveyor belt formed by the roller conveyor. As also shown, parcel 2001b is located in front of parcel 2001a in the conveying direction of the roller conveyor-corresponding to the direction of the arrow. By controlling the rollers on which only parcel 2001b is located, but not parcel 2001a, in a clockwise direction and thus for conveying parcel 2001b in the conveying direction, and by controlling the rollers on which only parcel 2001a is located in a counterclockwise direction, parcels 2001b and 2001a are separated from one another, or separation of parcels 2001a and 2001b by other means—for example by conveyor belts 2072—is supported accordingly.

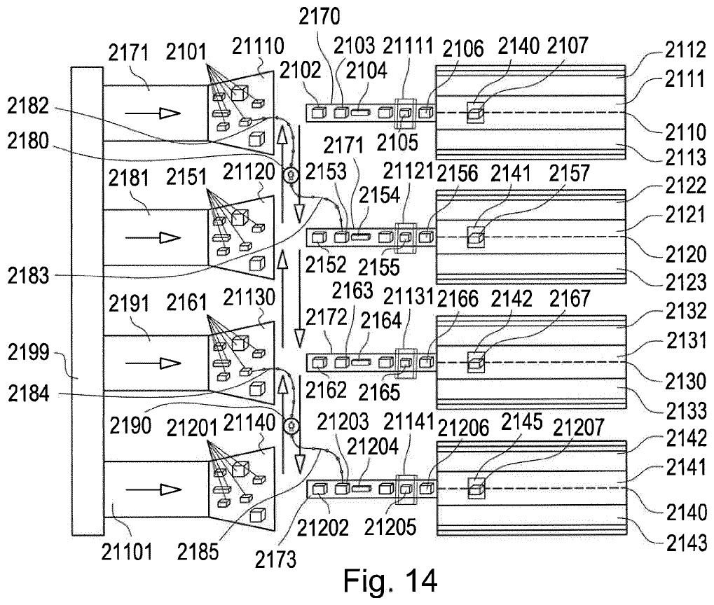

FIG. 14 shows a further advantageous embodiment of a transfer unit 5130, 5336 according to the invention. Here, no narrowing of the chutes, which are exemplarily marked in FIG. 14 with reference numerals 21110, 21120, 21130, 21140, is necessary, since the use of robots 2180, 2190 results in a separation between the chutes 21110, 21120, 21130, 21140 and the conveyor belts 2170, 2171, 2172, 2173 to the parcel delivery vehicles 2111, 2121, 2131, 2141: One of the robots preferably attends to 2-3 chutes 21110, 21120, 21130, 21140, in particular alternately. In a preferred embodiment, the robot 2180, 2190 attends to the chutes 21110, 21120, 21130, 21140 alternately by bringing several parcels 21110, 21120, 21130, 21140, preferably 3 to 10 individual parcels 2101, 2151, 2161, 21201 from one of the chutes 21110, 21120, 21130, 21140 and places them on a conveyor belt 2170, 2171, 2172, 2173 located in the vicinity of the respective chute 21110, 21120, 21130, 21140. The robot 2180, 2190 then moves to the next of the chutes 21110, 21120, 21130, 21140 and the respective adjacent conveyor belt.

It is appropriate to equip the robots 2180, 2181 with gripper arms 2182, 2183, 2184, 2185. Preferably, robot tools not shown are preferably attached to the gripper arms 2182, 2183, 2184, 2185 for reasons of simplification, preferably gripper systems, in particular one or more suction grippers, which are also called vacuum grippers. For example, the gripper systems known from DE 198 17 426 A1, in particular vacuum gripper systems, are adapted for this purpose. In particular, it is advantageous to use the measures described in this publication to monitor the gripping process, including a force sensor. This enables corrections to be made if parcels are gripped incorrectly, as forces outside a tolerance range can be measured and used to vary the control of the gripping process.

Furthermore, it is appropriate to equip the gripper arms with one or more sensor modules, in particular at least one force sensor, in order to measure the force on the parcel to be lifted, in particular the parcels 2101, 2151, 2161, 21201. Furthermore, the use of position sensors that are suitable for measuring a relative position or a distance between the parcel and the gripper or for determining the start and end points of a movement is advantageous.

Preferably, a flexible gripping device is used to pick up the parcels, which is shown, for example, in DE 20 2007 013 673 U1. This gripping device has a gripper with a multi-link frame, which is adapted for the present invention in such a way that better adaptation to variable dimensions (geometries) of the parcels is made possible.

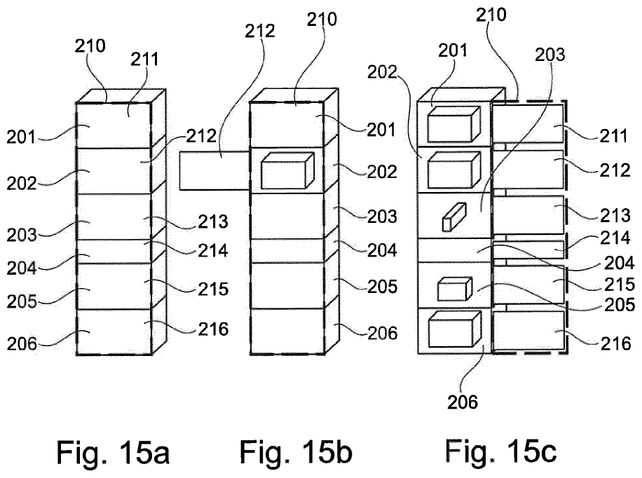

FIGS. 15a, 15b and 15c show a further embodiment of storage positions according to the invention, which are designed as lockers and in which loading is carried out from the side. FIG. 15a shows a section of a storage unit with storage positions 201, 202, 203, 204, 205, 206, which are arranged vertically one above the other in a kind of column. The doors 211, 212, 213, 214, 215, 216 of the individual lockers of the column are fixed in a joint frame 210 (shown dashed). As FIG. 15b shows, the doors 211, 212, 213, 214, 215, 216 of individual lockers, exemplarily shown for the door 212 of individual lockers, can be opened to one side (in the illustrated case to the left). The frame 210 is arranged so that it can be opened to the other side (to the right in the case shown) and thus opens all lockers in the column. The advantage of this embodiment over the individual compartment solution described in FIG. 4 is that instead of a device for each individual door, only one device is required for the frame of the column in order to open it, fix it, then carry out the loading and then close all the doors again by means of the frame.

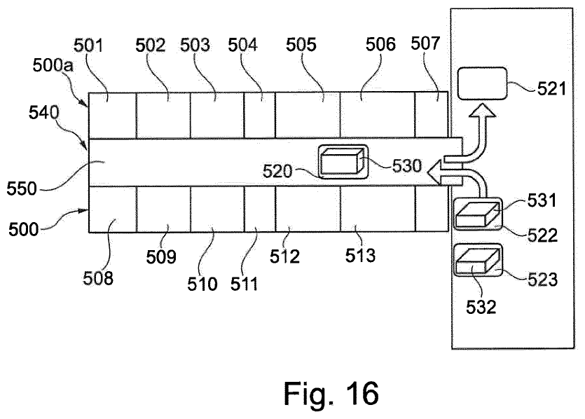

FIG. 16 shows an advantageous embodiment of parcel delivery vehicle loading in which a plurality of transport units 520, 521, 522, 523, which also function as loading units, move into the central aisle 550 of the loading space 540 of the parcel delivery vehicle and transfer a parcel into the associated storage position 501, 502, 503, 504, 505, 506, 507, 508, 509, 510, 511, 512, 513 of the storage units 500, 500a, and then move out again so that the next transport unit can move in. Here, 522, 523 denotes transport units loaded with parcels before entering the loading space 540 of the parcel delivery vehicle, 520 denotes a transport unit in the central aisle 550 of the loading space 540 of the parcel delivery vehicle before the parcel is moved into a storage position, and 521 denotes an empty transport unit after leaving the loading space 540 of the parcel delivery vehicle.

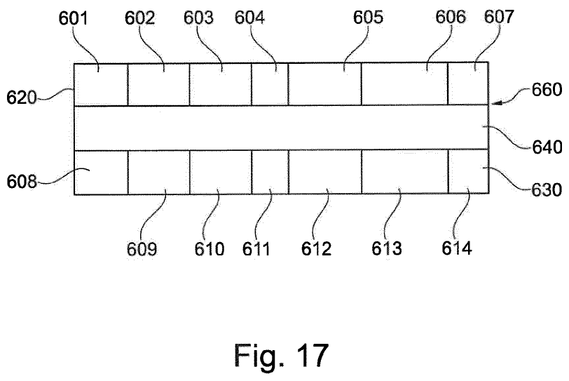

FIG. 17 shows a top view of the arrangement of the storage units 620, 630 along a central aisle 640 and of storage positions (exemplary 601, 602, 603, 604, 605, 606. 607, 608, 609, 610, 611, 612 in the loading space 660 of a parcel delivery vehicle.

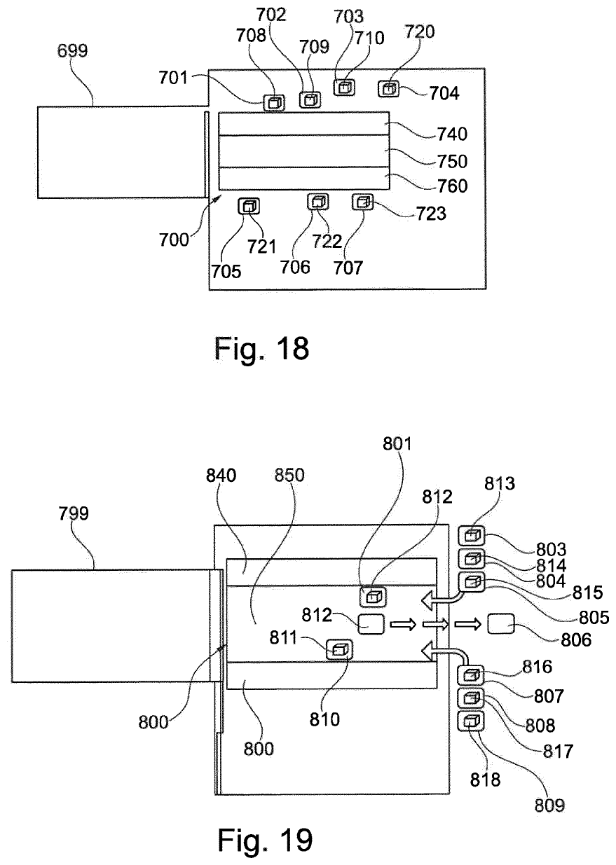

FIGS. 18 and 19 show a further embodiment of the loading of parcel delivery vehicles by means of the system according to the invention. In both cases, the storage unit 700, 800 is arranged such that it can be pulled out or moved out of the loading space 699, 799 of the parcel delivery vehicle. FIG. 18 shows the pulled-out storage unit 700, in which the storage positions are accessible not only from the central aisle 750, but also from the outside, and transport units 701, 703, 704, 705, 706, 707 transport the parcels simultaneously to both sides 740, 760 of the central aisle 750 for storage in the storage positions.

FIG. 19 shows a storage unit that can be manually or automatically pulled apart (widened) after being pulled out or moved out of the loading space 799 of the parcel delivery vehicle. In this case, the widening is designed such that parcels can be stored simultaneously in the storage positions on both sides of the storage unit 800. In the embodiment shown in FIG. 19, the central aisle is widened to such an extent that transport units 801, 803, 804, 807, 808, 809, 810 can approach the left and right shelves simultaneously and there is enough space in between for empty transport units 806, 812 to leave the storage unit 800 in the middle 850 at the same time. Furthermore, transport units 803, 804, 805, 806, 807, 808, 809 loaded with parcels 813, 814, 815, 816, 817, 818 are shown waiting to enter the storage unit 800. In accordance with the invention, it is also possible to perform the loading from the side shown in FIG. 18 and the loading through the center aisle shown in FIG. 19 in parallel.

### Flexible Shelving Systems

FIGS. 20, 20a, 20b show a shelving system. The shelving system 4310 according to the invention is particularly suitable for use as a storage unit of a parcel delivery vehicle according to the invention. However, the shelving system shown is not limited to such an application.

The shelving system shown is characterized by the fact that shelves 4320, 4321, 4332 and/or lateral limiting partitions of the storage positions 4322 can be arranged in a sliding manner.

This makes it possible to adapt the distance between different horizontal or vertical levels of the rack to variable requirements. It is particularly advantageous to adapt the storage unit to the number and/or dimensions of goods to be stored, including the parcels shown in this application.

Alternatively, according to the invention, it is possible to design the shelves 4320, 4321, 4332 without limiting partitions and to identify storage positions by visual markings, in particular numbers, barcodes, matrix codes, light-emitting diodes or laser pointers.

In a further embodiment, the storage position on the shelves 4320, 4321, 4332 can also be displayed using technical aids, in particular data glasses (smart glasses).

The embodiments shown here are only examples of the present invention and should therefore not be understood to be limiting. Alternative embodiments contemplated by the skilled person are equally encompassed by the scope of protection of the present invention.

What is claimed is:

1. A system for the automatic loading of parcel delivery vehicles, the system comprising:
at least one pick-up unit for picking up individual parcels, at least one transport unit for transporting individual parcels, at least one loading unit for loading parcel delivery vehicles and a control component, the parcel delivery vehicles being equipped with storage units which have a plurality of storage positions and are set up in such a way that at least one loading unit has access to each storage position in such a way that the loading unit can transfer parcels to the storage position of the storage unit and in that the control component is arranged to control a loading process and/or an unloading process of a parcel delivery vehicle by the interaction of the pick-up unit, transport unit and loading unit and to store information about the storage of each parcel and the position of each parcel in the storage unit and to make the information about the position of each parcel in the storage unit accessible to a delivery person upon reaching a handover location for the respective parcel prior to a handover of the parcel, and
wherein a freely movable robot that can be controlled by the control component takes over functions of the pick-up unit, the transport unit and the loading unit.

2. The system according to claim 1, the freely movable robot, which can be controlled by the control component, is equipped with a gripper arm.

3. The system according to claim 1, wherein the freely movable robot, which can be controlled by the control component, has a transfer platform.

4. The system according to claim 1, wherein the storage of the individual parcels in storage positions of the storage units takes place taking into account parcel identification characteristics of the individual parcels.

5. The system according to claim 1, wherein the control component, during a stay of the parcel delivery vehicle in an area of a delivery depot, transmits data elements relating to the parcels stored in the storage positions of a storage unit of the parcel delivery vehicle to a delivery terminal comprising:
at least one parcel identification characteristic that is suitable for enabling reliable identification of a respective parcel,
information identifying the storage position within the storage unit of the parcel delivery vehicle for the storage of the respective parcel, and
address and contact details of an intended recipient of the parcel.

6. The system according to claim 5, wherein the delivery terminal is a communication device that can be used for voice and data communication regardless of location, preferably a handheld scanner, notebook, tablet, smartphone, smart watch, or smart glasses.

7. The system according to claim 1, wherein the storage units are arranged on side walls of the parcel delivery vehicles in a longitudinal direction.

8. The system according to claim 7, wherein the storage units are shelving units.

9. The system according to claim 8, wherein the shelving units and/or lateral limiting partitions of the storage positions are arranged so that they can be moved.

10. The system according to claim 8, wherein the shelves have no limiting partitions and the storage positions are identified by visual markings, in particular numbers, barcodes, matrix codes, LEDs or laser pointers.

11. The system according to claim 10, wherein the storage of parcels in the storage unit takes place from a rear of a loading space of the parcel delivery vehicle through a door which occupies the full width of the loading space or a part thereof, the width of the door having to be selected at least such that a transport unit can move into and out of the storage unit.

12. The system according to claim 11, wherein the storage of parcels in the storage unit or the removal of parcels from the storage unit takes place from the outside via open side walls of the parcel delivery vehicle.

13. The system according to claim 11, wherein the storage unit is set up in such a way that it can be moved out of the loading space of the parcel delivery vehicle, loaded and/or unloaded outside the parcel delivery vehicle and moved back into the parcel delivery vehicle and preferably widened for loading or unloading and then narrowed again.

14. The system according to claim 1, wherein the storage unit is designed in the manner of lockers and can be opened from a side.

15. The system according to claim 14, wherein the lockers are each equipped with locker doors and a spring and fixation so that the locker doors open at an angle of 90° for loading and preferably close again automatically after loading.

16. The system according to claim 14, wherein storage positions are arranged vertically one above the other in a kind of column, and wherein doors of the individual lockers of a column are fixed in a joint frame, and the door of an individual locker can be opened to one side and the frame is arranged so that it can be opened to the other side and thus opens all the lockers of the column.

17. The system according to claim 1, wherein a load compartment of the parcel delivery vehicle is designed in such a way that it can be separated from a mobile part of the vehicle.
